(19) United States
(12) Patent Application Publication
(10) Pub. No.: US 2020/0321820 A1
(43) Pub. Date: Oct. 8, 2020

(54) STATOR AND METHOD OF MANUFACTURING STATOR

(71) Applicant: FANUC CORPORATION, Minamitsuru-gun (JP)

(72) Inventor: Hiroki TOUFUKU, Yamanashi-ken (JP)

(21) Appl. No.: 16/837,788

(22) Filed: Apr. 1, 2020

(30) Foreign Application Priority Data
Apr. 3, 2019 (JP) 2019-071299

(51) Int. Cl. H02K 3/38; H02K 15/10; H02K 15/12

(52) U.S. Cl. CPC H02K 3/38; H02K 15/12; H02K 15/105

(57) ABSTRACT

A stator of an electric motor includes: an iron core; a coil provided in the iron core, with a coil end formed at each of both ends of the iron core in an axial direction of the electric motor; a hardened impregnant configured to fix the coil ends; and an insulative covering member configured to cover the coil end at each of the both ends, wherein the coil ends each have an outer circumferential portion and an inner circumferential portion, and at least the outer circumferential portion of the coil end is covered by the covering member.

### CROSS-REFERENCE TO RELATED APPLICATION

This application is based upon and claims the benefit of priority from Japanese Patent Application No. 2019-071299 filed on Apr. 3, 2019, the contents of which are incorporated herein by reference.

### BACKGROUND OF THE INVENTION

### Field of the Invention

The present invention relates to a stator of an electric motor that is less susceptible to failure and a method for manufacturing the stator.

### Description of the Related Art

A stator of an electric motor includes coils that are provided in an iron core in such a manner as to form coil ends. The coil ends are impregnated with an impregnant as described in Japanese Laid-Open Patent Publication No. 2013-219970.

The impregnant is a temperature-hardening adhesive. The impregnant is hardened to fix the coil ends to the iron core.

### SUMMARY OF THE INVENTION

Liquid impregnant that was impregnated into the coil ends mostly comes out before it is hardened. If the amount of impregnant impregnated in the coil ends is insufficient, the coil ends are not fixed even after the impregnant is hardened. If the electric motor is operated with the coil ends not properly fixed, then the coil ends may be damaged by vibration during the operation. The damaged coil ends can lead to a failure of the electric motor.

Accordingly, an object of the present invention is to provide a stator of an electric motor that is less susceptible to failure and a method for manufacturing the stator.

According to one aspect of the present invention, a stator of an electric motor includes: an iron core; a coil provided in the iron core, with a coil end formed at each of both ends of the iron core in an axial direction of the electric motor; a hardened impregnant configured to fix the coil ends; and an insulative covering member configured to cover the coil end at each of the both ends, wherein the coil ends each have an outer circumferential portion and an inner circumferential portion, and at least the outer circumferential portion of the coil end is covered by the covering member.

According to another aspect of the present invention, a method for manufacturing a stator of an electric motor includes: a coil formation step of providing a coil in an iron core, with a coil end formed at each of both ends of the iron core in an axial direction of the electric motor; a covering step of covering the coil end with an insulative covering member at each of the both ends; an impregnation step of impregnating each of the coil ends covered by the covering member with an impregnant; and a hardening step of hardening the impregnant with which the coil is impregnated, wherein the coil ends each have an outer circumferential portion and an inner circumferential portion, and the covering step covers at least the outer circumferential portion of the coil end with the covering member.

According to the present invention, a stator of an electric motor that is less susceptible to failure and a method for manufacturing the stator are provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1A is an overall configuration diagram of a stator according to an embodiment, and FIG. 1B is a configuration diagram, with covering members removed from FIG. 1A;

FIG. 2 is a flowchart illustrating a method for manufacturing the stator of the embodiment;

FIG. 3 is a first diagram showing the stator of the embodiment during its manufacturing process; and

FIG. 4 is a second diagram showing the stator of the embodiment during its manufacturing process.

### DESCRIPTION OF THE PREFERRED EMBODIMENTS The present invention will now be described in detail referring to the accompanying drawings in conjunction with preferred embodiments.

### First Embodiment

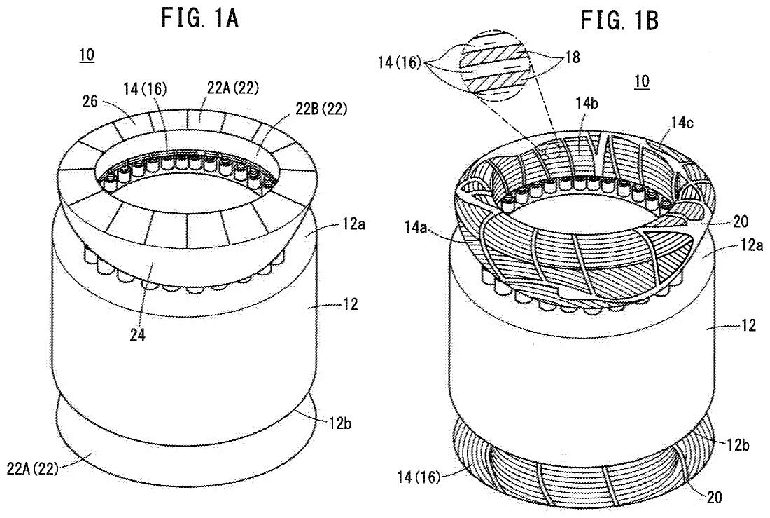

FIG. 1A is an overall configuration diagram of a stator 10 of an embodiment. FIG. 1B is a configuration diagram showing the stator 10 of FIG. 1A, with its covering members 22 removed therefrom.

The stator 10 of this embodiment is one of the parts that constitute an electric motor together with a rotor and a shaft. The stator 10 includes an iron core 12, a coil or coils 16 provided in the iron core 12 in such a manner as to form coil ends 14 respectively at both ends 12a, 12b of the iron core 12 in the axial direction of the electric motor, and hardened impregnant 18 for fixing the coil ends 14. The term “axial direction” means a direction that extends along the longitudinal direction of the shaft serving as the main rotary axis of the electric motor.

Now, in order to simplify the description, of both the ends 12a, 12b of the iron core 12, the end 12a will be mainly described. However, note that the description below is applicable also to the other end 12b of both ends 12a, 12b of the iron core 12.

The coils 16 are made of wire material having electric conductivity. The wire material having electric conductivity can be an enameled wire, for example. The coil ends 14 of the coils 16 each have an outer circumferential portion 14a, an inner circumferential portion 14b, and an end surface 14c that extends between the outer circumferential portion 14a and the inner circumferential portion 14b.

The impregnant 18 is a temperature-hardening adhesive that hardens when heated. In this embodiment, it is assumed that an ester-based solventless impregnant is used as the impregnant 18. The impregnant 18 is hardened in a state that gaps in the coils 16 at the coil ends 14 are impregnated with the impregnant. The coil ends 14 are thus fixed to the iron core 12 firmly. This reduces the possibility that the wire material forming the coil ends 14 rubs due to vibration occurring during operation of the electric motor having the stator 10. This reduces the possibility of failure of the stator 10.

The stator 10 further includes tightly binding thread (or string) 20 that is wound around each coil end 14 to thereby bind the coil end 14, and two covering members 22 (22A, 22B) that cover the coil end 14.

The tightly binding thread 20 enables the coil end 14 to be further firmly fixed to the iron core 12. Binding the coil end 14 with the tightly binding thread 20 also suitably shapes the coil end 14. The coil end 14 may be bound with other material in place of the tightly binding thread 20 or in addition to the tightly binding thread 20. Other material than the tightly binding thread 20 for binding the coil end 14 can be a nonwoven fabric, for example.

The covering members 22 in this embodiment are, for example, an insulative adhesive tape that contains silicone as its material. The covering members 22 being an adhesive tape have a surface that has adhesion (an adhesive surface). The adhesive surface of the covering member 22 is stuck on the coil end 14, and covers the coil end 14 without coming unstuck.

Of the two covering members 22, a first covering member 22A has an elongated portion 24 that is formed into an elongated member and that is wound entirely around the outer circumferential portion 14a. The first covering member 22A further includes a plurality of strip portions 26 that are each formed into a short strip shape and that extend on the surface of the coil end 14 from the elongated portion 24 toward the inner circumferential portion 14b, so as to cover the end surface 14c.

Of the two covering members 22, a second covering member 22B circumferentially extends along the entire inner circumferential portion 14b. Like the elongated portion 24 of the first covering member 22A, the second covering member 22B is also formed into an elongated member.

In this way, in this embodiment, the first covering member 22A and the second covering member 22B cover the outer circumferential portion 14a, the end surface 14c, and the inner circumferential portion 14b of the coil end 14. This reduces the possibility of damage to the coil end 14 of the stator 10 during transportation of the stator 10 in the manufacturing process of the electric motor and during operation of the electric motor.

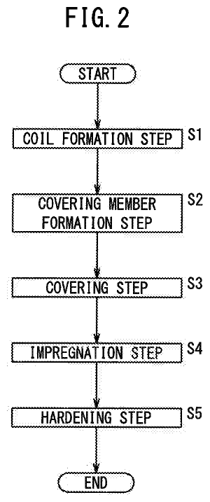

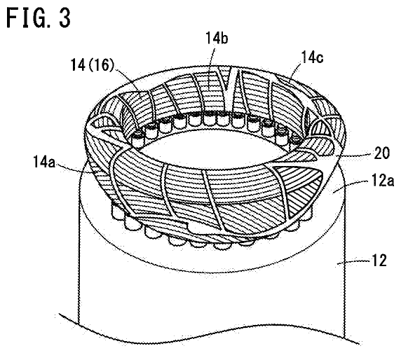

FIG. 2 is a flowchart illustrating a method for manufacturing the stator 10 of the embodiment. FIG. 3 is a first diagram showing the stator 10 of the embodiment during its manufacturing process.

The method for manufacturing the stator 10 above will be described. First, the coils 16 are provided on the iron core 12 (coil formation step S1). In this step, the coils 16 are provided on the iron core 12 in such a manner as to form the coil ends 14 respectively at both ends 12a, 12b of the iron core 12 in the axial direction of the electric motor. The coils 16 are not particularly limited, but it is assumed that this embodiment uses an enameled wire to form the coils 16. In this process, the outer shape of the coil end 14 can be easily adjusted in a suitable manner by winding the tightly binding thread 20 around the coil end 14. The structure shown in FIG. 3 is thus obtained. As shown in FIG. 3, the coil end 14 has the outer circumferential portion 14a, the inner circumferential portion 14b, and the end surface 14c that extends between the outer circumferential portion 14a and the inner circumferential portion 14b.

Next, the insulative covering members 22 for covering the coil end 14 are prepared (covering member formation step S2). This embodiment prepares the first covering member 22A having the elongated portion 24 having an elongated shape and the multiple strip portions 26 each having a short-strip shape extending in a widthwise (or transverse) direction from the elongated portion 24, and the second covering member 22B having an elongated shape.

In this embodiment, the covering members 22 are formed from an insulative adhesive tape that contains silicone as its material. It is easy to appropriately adjust the shape since adhesive tape is easy to cut. For example, the first covering member 22A having the elongated portion 24 and the plurality of strip portions 26 can be formed easily by making cuts in a rectangular adhesive tape.

As can be understood from the description above, the covering member formation step S2 may be performed prior to the coil formation step S1, or may be performed in parallel therewith.

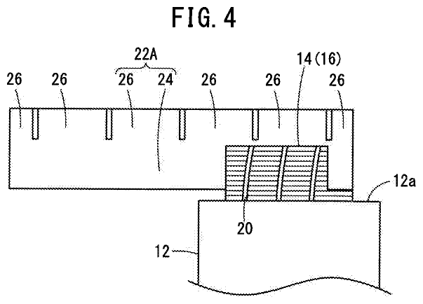

FIG. 4 is a second diagram illustrating the stator 10 of the embodiment during its manufacturing process.

Next, the coil end 14 is covered with the covering members 22 (covering step S3). In this step, first, as shown in FIG. 4, the elongated portion 24 of the first covering member 22A, which has the elongated portion 24 and the plurality of strip portions 26, is wound around the outer circumferential portion 14a of the coil end 14, to thereby cover the entire circumference of the outer circumferential portion 14a. Next, the plurality of strip portions 26 are bent toward the inner circumferential portion 14b side, so as to cover the entire circumference of the end surface 14c with the strip portions 26. Then, the long, second covering member 22B is placed along and on the inner circumferential portion 14b of the coil end 14, thereby covering the entire circumference of the inner circumferential portion 14b. As mentioned above, this embodiment uses an adhesive tape as the covering members 22, so that the outer circumferential portion 14a, end surface 14c, and inner circumferential portion 14b of the coil end 14 can be covered through the simple work of sticking the covering members 22 on the coil end 14.

When the covering step S3 is finished, a structure which looks similar to that shown in FIG. 1A is obtained, except that the coil end 14 is not impregnated with the hardened impregnant 18.

Next, the coil end 14 covered by the covering members 22 is impregnated with the impregnant 18 (impregnation step S4). The impregnant 18 is not particularly limited, but it can be an ester-based solventless impregnant, or an organic solvent in which resin is dissolved in a solvent, for example. In this embodiment, an ester-based solventless impregnant is used as the impregnant 18. The coil end 14 is impregnated with the impregnant 18 by preparing a tank in which the impregnant 18 is stored and immersing the iron core 12 and the coils 16 provided on the iron core 12 in the impregnant 18 stored in the tank. In this process, the impregnant 18 is impregnated into the coil end 14 through gaps from which part of the coils 16 is exposed, between the coil end 14 and the iron core 12 (see FIG. 1A), for example.

Next, the iron core 12 and the coils 16 are pulled up from the tank and then the impregnant 18, with which the coil end 14 is impregnated, is heated to be hardened (hardening step S5). In this embodiment, the coil end 14 is covered with the covering members 22. This reduces the amount of impregnant 18 that comes out from the coil end 14 during the process from the pulling up of the coil end 14 to the hardening of the impregnant 18.

The structure shown in FIG. 1A is thus obtained by the manufacturing method above. Covering the coil end 14 with the covering members 22 before the impregnation step S4 enables the coil end 14 of the stator 10 to be impregnated with a sufficient amount of hardened impregnant 18. This enables the coil end 14 to be fixed to the iron core 12 in a desirable manner. This in turn reduces the possibility of failures of the stator 10 when the electric motor having the stator 10 is operated.

### Modifications

The embodiment has been explained as an example of the present invention and the embodiment can of course be modified or improved in various manners. It is clear from recitation of claims that such modified or improved embodiments are also included in the technical scope of the present invention.

### First Modification

The covering members 22 are not limited to an adhesive tape that contains silicone as material, as long as the members are insulative and have adhesion sufficient to stick fast to the coil end 14. For example, the covering members 22 may be made of film material (wrap) that is heat-resistant and insulative.

### Second Modification

The embodiment above has described the first covering member 22A that covers the outer circumferential portion 14a and the end surface 14c of the coil end 14, and the second covering member 22B that covers the inner circumferential portion 14b of the coil end 14. The first covering member 22A may be changed to cover the outer circumferential portion 14a, end surface 14c, and inner circumferential portion 14b. When the first covering member 22A further covers the inner circumferential portion 14b, then the strip portions 26 are formed to cover not only the end surface 14c but also the inner circumferential portion 14b. The second covering member 22B may be omitted when the first covering member 22A can thus cover the outer circumferential portion 14a, end surface 14c, and inner circumferential portion 14b of the coil end 14.

As another example of this modification, for example, the shape of the first covering member 22A and the shape of the second covering member 22B described in the embodiment may be exchanged. In this case, an elongated, first covering member 22A may cover the outer circumferential portion 14a of the coil end 14. Also, a second covering member 22B may have a long, elongated portion 24 to cover the inner circumferential portion 14b of the coil end 14, and a plurality of strip portions 26 to cover the end surface 14c.

Further, as another example of this modification, for example, the stator 10 may include three or more covering members 22. In this case, a plurality of covering members 22 may be provided in layers.

### Third Modification

Other methods for impregnating the coil end 14 with the impregnant 18 may be used, instead of the method (immersion) described in the embodiment. For example, in a method, an impregnant 18 in liquid form is dropped to the coil end 14. In this method, the impregnant 18 is dropped to the inner circumferential portion 14b of the coil end 14. Then, the impregnant 18 gradually soaks into the coil end 14 from the inner circumferential portion 14b to the outer circumferential portion 14a.

In this case, if the inner circumferential portion 14b is covered by the covering member 22, the covering member 22 hinders the dripping of the impregnant 18, so that it is difficult to impregnate the coil end 14 with the impregnant 18. Accordingly, when the coil end 14 is impregnated with the impregnant 18 by dropping it to the inner circumferential portion 14b, the inner circumferential portion 14b need not necessarily be covered by the covering member 22, as long as at least the outer circumferential portion 14a of the coil end 14 is covered by the covering member 22. This reduces the amount of impregnant 18, having been dropped, that comes out from the outer circumferential portion 14a before it is hardened. In this modification, the end surface 14c, in addition to the outer circumferential portion 14a, may also be covered with the covering member 22. This reduces the amount of dropped impregnant 18 that comes out from the outer circumferential portion 14a and end surface 14c before being hardened.

### Fourth Modification

The covering member(s) 22 may have one or more holes. If the first covering member 22A and the second covering member 22B both are used, both the first covering member 22A and the second covering member 22B may have a hole, or one of them may have a hole. A manufacturing method of a stator 10 having such covering member(s) 22 with hole(s) may further include a step (hole formation step) of forming hole(s) in the covering member(s) 22 prior to the impregnation step S4.

As mentioned earlier, impregnating the coil end 14 with an insufficient amount of impregnant 18 may lead to a failure of the stator 10. However, on the other hand, impregnating the coil end 14 with an excessive amount of impregnant 18 also causes a failure of the stator 10. For example, such failures of the stator 10 that would be caused by excessive impregnant 18 include a situation where the volume of the coil end 14, including the impregnant 18, exceeds the value allowable in design.

A hole formed in the covering member(s) 22 allows the excessive amount of impregnant 18 to be discharged through the hole after the impregnation step. Thus, according to this modification, it is possible to reduce the possibility of failure of the stator 10 that would be caused by an excessive amount of impregnant 18.

### Fifth Modification

Now, for the sake of convenience, the tightly binding thread 20, used to bind the coil end 14 in the embodiment, will be referred to as “first tightly binding thread 20”. The stator 10 may further include second tightly binding thread separately from the first tightly binding thread 20, in order to bind the coil end 14 over the covering members, i.e., with the covering members 22 interposed between the coil end 14 and the thread. In this case, the method for manufacturing the stator 10 may further include, between the covering step S3 and the hardening step S5, a reinforcing step of binding the coil end 14 over the covering members 22, with the second tightly binding thread.

The second tightly binding thread binds the coil end 14 over the covering members 22, in the areas of the outer circumferential portion 14a, inner circumferential portion 14b, and end surface 14c of the coil end 14 that are covered with the covering members 22. With this configuration, the covering members 22 can adhere more intimately to the coil end 14. Method for binding the coil end 14 with the second tightly binding thread is not particularly limited, and it is possible to adopt the same method as that of the first tightly binding thread 20, for example. Also, like the first tightly binding thread 20, the second tightly binding thread may be replaced by a nonwoven fabric.

### Sixth Modification

The embodiments and modifications described above may be arbitrarily combined within a range in which no inconsistencies occur therein.

### Invention Obtained from Embodiments

The invention graspable from the embodiments and modifications described above will be recited below.

### <First Invention>

A stator (10) of an electric motor includes: an iron core (12); a coil (16) provided in the iron core (12), with a coil end (14) formed at each of both ends (12a, 12b) of the iron core (12) in an axial direction of the electric motor; a hardened impregnant (18) configured to fix the coil ends (14); and an insulative covering member (22) configured to cover the coil end (14) at each of the both ends (12a, 12b), wherein the coil ends (14) each have an outer circumferential portion (14a) and an inner circumferential portion (14b), and at least the outer circumferential portion (14a) of the coil end (14) is covered by the covering member (22).

Thus, a stator (10) of an electric motor that is less susceptible to failure is provided.

The covering member (22) may have an adhesive surface and the surface may be stuck on each of the coil ends (14). Thus, each coil end (14) is covered by the covering member (22) without the covering member (22) coming unstuck.

The covering member (22) that covers the outer circumferential portion (14a) may have a long, elongated portion (24) that is wound along the outer circumferential portion (14a). Thus, the outer circumferential portion (14a) is covered by the covering member (22).

The coil ends (14) may each include an end surface (14c) that extends between the outer circumferential portion (14a) and the inner circumferential portion (14b), and the end surface (14c) of each of the coil ends (14) may be covered by the covering member (22). Thus, the end surface (14c) of the coil end (14) is covered by the covering member (22).

The inner circumferential portion (14b) of each of the coil ends (14) may be covered by the covering member (22).

Thus, the inner circumferential portion (14b) of the coil end (14) is covered by the covering member (22).

The covering member (22) that covers at least the outer circumferential portion (14a) may include a plurality of strip portions (26), each formed into a short strip shape, the strip portions extending on a surface of the coil end (14) from the elongated portion (24) toward the inner circumferential portion (14b) and covering at least the end surface (14c) of the end surface (14c) and the inner circumferential portion (14b). Thus, the outer circumferential portion (14a) is wound with the elongated portion (24) and the end surface (14c) and the inner circumferential portion (14b) are covered with the plurality of strip portions (26).

The covering member (22) may include a plurality of the covering members (22), and the plurality of covering members (22) may include a first covering member (22A) configured to cover at least the outer circumferential portion (14a) of the coil end (14), and a second covering member (22B) configured to cover at least the end surface (14c) or the inner circumferential portion (14b) of the coil end (14). Thus, the coil end (14) is covered by the plurality of covering members (22).

The covering member (22) may have one or more holes. Thus, surplus of the impregnant (18) is discharged from the coil end (14).

The stator (10) may further include a tightly binding thread or a nonwoven fabric that binds the coil end (14) over the covering member (22). Thus, the coil end (14) is fixed to the iron core (12) more firmly.

### <Second Invention>

A method for manufacturing a stator (10) of an electric motor includes: a coil formation step of providing a coil (16) in an iron core (12), with a coil end (14) formed at each of both ends (12a, 12b) of the iron core (12) in an axial direction of the electric motor; a covering step of covering the coil end (14) with an insulative covering member (22) at each of the both ends (12a, 12b); an impregnation step of impregnating each of the coil ends (14) covered by the covering member (22) with an impregnant (18); and a hardening step of hardening the impregnant (18) with which the coil (16) is impregnated, wherein the coil ends (14) each have an outer circumferential portion (14a) and an inner circumferential portion (14b), and the covering step covers at least the outer circumferential portion (14a) of the coil end (14) with the covering member (22).

Thus, a method of manufacturing the stator (10) that is less susceptible to failure is provided.

The coil ends (14) may each include an end surface (14c) that extends between the outer circumferential portion (14a) and the inner circumferential portion (14b), and the covering step may cover the end surface (14c) with the covering member (22). Thus, the end surface (14c) is covered with the covering member (22).

The covering step may cover the inner circumferential portion (14b) of each of the coil ends (14) with the covering member (22). Thus, the inner circumferential portion (14b) is covered with the covering member (22).

The stator manufacturing method may further include, prior to the covering step, a covering member formation step of forming the covering member (22) to form a long, elongated portion (24) and a plurality of strip portions (26) each formed into a short strip shape and extending in a transverse direction from the elongated portion (24), wherein the covering step winds the elongated portion (24) entirely around the outer circumferential portion (14a) and covers at least the end surface (14c) of the end surface (14c) and the inner circumferential portion (14b), with the plurality of strip portions (26). Thus, the outer circumferential portion (14a) is wound with the elongated portion (24) and the end surface (14c) and the inner circumferential portion (14b) are covered with the plurality of strip portions (26).

The covering member (22) may include a plurality of the covering members (22), and the covering step may cover each of the coil ends (14) with a first covering member (22A) of the covering members that covers at least the outer circumferential portion (14a) of the coil end (14), and a second covering member (22B) of the covering members that covers at least the end surface (14c) or the inner circumferential portion (14b) of the coil end (14). Thus, the coil end (14) is covered with the plurality of covering members (22).

The stator manufacturing method may further include, between the covering step and the hardening step, a reinforcing step of binding each of the coil ends (14) over the covering member (22), with a tightly binding thread or a nonwoven fabric. Thus, the coil end (14) is fixed to the iron core (12) more firmly.

What is claimed is:

1. A stator of an electric motor, comprising:
an iron core;
a coil provided in the iron core, with a coil end formed at each of both ends of the iron core in an axial direction of the electric motor;
a hardened impregnant configured to fix the coil ends; and
an insulative covering member configured to cover the coil end at each of the both ends,
wherein the coil ends each have an outer circumferential portion and an inner circumferential portion, and at least the outer circumferential portion of the coil end is covered by the covering member.

2. The stator according to claim 1, wherein the covering member has an adhesive surface and the surface is stuck on each of the coil ends.

3. The stator according to claim 1, wherein the covering member that covers the outer circumferential portion has a long, elongated portion that is wound along the outer circumferential portion.

4. The stator according to claim 3, wherein
the coil ends each include an end surface that extends between the outer circumferential portion and the inner circumferential portion, and
the end surface of each of the coil ends is covered by the covering member.

5. The stator according to claim 4, wherein the inner circumferential portion of each of the coil ends is covered by the covering member.

6. The stator according to claim 4, wherein the covering member that covers at least the outer circumferential portion includes a plurality of strip portions, each formed into a short strip shape, and the strip portions extend on a surface of the coil end from the elongated portion toward the inner circumferential portion and cover at least the end surface of the end surface and the inner circumferential portion.

7. The stator according to claim 5, wherein
the covering member comprises a plurality of covering members, and
the plurality of covering members include a first covering member configured to cover at least the outer circumferential portion of the coil end, and a second covering member configured to cover at least the end surface or the inner circumferential portion of the coil end.

8. The stator according to claim 1, wherein the covering member has one or more holes.

9. The stator according to claim 1, further comprising a tightly binding thread or a nonwoven fabric that binds the coil end over the covering member.

10. A method for manufacturing a stator of an electric motor, comprising:
a coil formation step of providing a coil in an iron core, with a coil end formed at each of both ends of the iron core in an axial direction of the electric motor;
a covering step of covering the coil end with an insulative covering member at each of the both ends;
an impregnation step of impregnating each of the coil ends covered by the covering member with an impregnant; and
a hardening step of hardening the impregnant with which the coil is impregnated,
wherein the coil ends each have an outer circumferential portion and an inner circumferential portion, and the covering step covers at least the outer circumferential portion of the coil end with the covering member.

11. The stator manufacturing method according to claim 10, wherein
the coil ends each include an end surface that extends between the outer circumferential portion and the inner circumferential portion, and
the covering step covers the end surface with the covering member.

12. The stator manufacturing method according to claim 11, wherein the covering step covers the inner circumferential portion of each of the coil ends with the covering member.

13. The stator manufacturing method according to claim 11, further comprising, prior to the covering step, a covering member formation step of forming the covering member to form a long, elongated portion and a plurality of strip portions each formed into a short strip shape and extending in a transverse direction from the elongated portion,
wherein the covering step winds the elongated portion entirely around the outer circumferential portion and covers at least the end surface of the end surface and the inner circumferential portion, with the plurality of strip portions.

14. The stator manufacturing method according to claim 12, wherein
the covering member comprises a plurality of covering members, and
the covering step covers each of the coil ends with a first covering member of the covering members that is configured to cover at least the outer circumferential portion of the coil end, and a second covering member of the covering members that is configured to cover at least the end surface or the inner circumferential portion of the coil end.

15. The stator manufacturing method according to claim 10, further comprising, between the covering step and the hardening step, a reinforcing step of binding each of the coil ends over the covering member, with a tightly binding thread or a nonwoven fabric.
